(19) United States
(12) Patent Application Publication
(10) Pub. No.: US 2010/0205295 A1
(43) Pub. Date: Aug. 12, 2010

(54) System Consisting Of A Plurality Of Cooking Devices With Respective Network-Based Monitoring Devices

(76) Inventors: Cornelia Dietmayer, Weil (DE); Ingrid Stolnhofer, Monchen (DE); Bemard Schûhler, Grossailingen (DE); Laszlo Dobos, Erdweg/Hof (DE); Erwin Schuller, Wolfratshausen (DE); Alexey Govorukhin, Landsberg (DE); Wilhelm Marz, Siebnach (DE); Stefan Pechaigner, Dachau (DE)

Correspondence Address: Patent Group 2N;Jones Day, North Point, 901 Lakeside Avenue, Cleveland, OH, 44114, US

(21) Appl. No.: 12/697,733

(22) Filed: Feb. 1, 2010

Related U.S. Application Data
(63) Continuation of application No. PCT/DE2008/001228, filed on Jul. 23, 2008.

(30) Foreign Application Priority Data
Aug. 1, 2007 (DE) 102007036511.1

(51) Int. Cl. G06F 15/173

(52) U.S. Cl. 709/224

(57) ABSTRACT

A system for synchronous monitoring of a cooking process of a plurality of cooking devices via the internal web browser of one of the cooking devices comprises a plurality of cooking devices that can be interconnected via interfaces. Each cooking device is connected to at least one internal web server that is connected to a network and that provides services for the monitoring, control or analysis of at least one of the cooking devices. At least one internal web browser is provided that is connected to the network and that can use at least the services of one of the internal web servers.

### CROSS-REFERENCE TO RELATED APPLICATIONS

The present application is a continuation of international patent application No. PCT/DE2008/001228, entitled “System consisting of a plurality of cooking devices with respective network-based monitoring devices,” filed on Jul. 23, 2008. This application and the international patent application claim priority from German Patent Application No. 10 2007 036 511.1, filed on Aug. 1, 2007. All of these are hereby incorporated into the present application by reference.

### BACKGROUND

1. Technical Field

The invention relates to a system consisting of a plurality of cooking devices with respective network-based monitoring devices.

2. Description of the Related Art

In the state of art, different cooking devices are known wherein each of them communicates via a network connection with a server or with a data processor.

WO 97/41392 A2 describes for instance a network for the monitoring and maintenance of a great number of cooking devices arranged spaced apart and is controlled by a central monitoring unit. The communication between the central monitoring unit and the cooking devices is accomplished via interconnected base stations which are arranged in the vicinity of the cooking devices.

Moreover, a method for the remote analysis of a cooking device as well as a cooking device for the implementation of such a method are known from DE 10 2006 062 244. The cooking device which is disclosed therein is provided with a memory and is connectable with a server via an interface. For the remote analysis, the server may read data of the cooking device from the memory.

DE 102 01 217 A1 discloses a cooking device and a method for data protection of control data or measuring data of a cooking device with the cooking device having access to a web server via an interne connection. Upon an authentication of the cooking device vis-a-vis the web server having been made, if appropriate, the control data or the measuring data may be secured in a protected memory area of the web server.

A disadvantage of the state of the art is that a network-based communication with the cooking device is possible only from a specific central server or a comparable data processor. The possible access points within the network to the cooking device are thus limited.

From DE 102 11 064 A1 for instance a portable information device for the provision of information on a plurality of different electronic household appliances to a user of the portable information device is known, wherein the information device comprises a unit for the identification of one of the devices which is located in an interaction area of a user, a unit for receiving information on the identified device and a unit for displaying the received information to the user. This would make it possible that for each electronic household appliance all information is displayed to a user in a fast and clearly arranged manner with always only those information of the household appliance being displayed with which the user would indeed like to interact. For doing this, an information server is used.

US 2007/0086514 A1 discloses a device by means of which electric energy may be supplied to an electronic device providing moreover a communication access to the device with the device being able to contain a web server.

Moreover, DE 102 60 143 A1 discloses the transmission of data within a local household appliances network with the local household appliances network comprising at least a household appliance which can work within a network and at least a gateway to at least another network.

EP 1 477 908 A1 discloses a communication system with at least one electrical device and a server with the device being networked with the server, relevant data of the device being displayed on the server and the server being connectable with a call center by means of the internet. Upon demand, the call center has access to the server and/or to the device so that a desired state of the device can be brought about by external activities of the centre.

### SUMMARY

A system can be provided which contains a plurality of cooking devices which make it possible to monitor at least one of the cooking devices from as many points of a network as possible.

This can be achieved by a system having a plurality of cooking devices that can be interconnected via interfaces, each cooking device being connected to at least one internal web server that is connected to a network and that provides in the network services for the monitoring, control and/or analysis of at least one of the cooking devices, and at least one internal web browser that is connected to the network and that can use at least the services of one of the internal web servers so that a cooking process of all cooking devices can be monitored synchronously via the internal web browser of one of the cooking devices.

Moreover, it may be provided that each internal web server is a server of the services which are callable via the HTTP protocol.

It can also be provided that each internal web browser is a client that accesses the network via HTTP with the services preferably being web services.

A system can moreover include that the services of each internal web server are callable from at least one remote web browser which is connected to the network.

It may also be provided that each internal web browser uses the services of at least one remote web server which is connected to the network.

It is also proposed that at least the services of the internal web server comprise a control of the devices as well as a readout, a writing and/or a modification of settings and of cooking device configurations, a readout and/or a modification of the running times and running cycles of cooking processes, a readout of service, diagnosis and statistics data, as well as a creation, a management, an uploading and/or a downloading of cooking programs.

It may also be provided that through the use of the services of each internal web server each internal web browser is an active component of the operation of the cooking device concerned.

The internal web server can also be bi-directionally connected via a data line with an electronic control unit of the cooking device concerned.

It may furthermore be provided that the network comprises a local network of each cooking device with the local networks being inter-connectable via a respective interface or being connectable with another cooking device.

According to the invention it may be provided that the network comprises the internet with in particular the local network being connectable via an interface with the internet.

The invention also proposes that the interface is a web interface.

A system according to the invention may also be characterized in that services for a cooking device from a central web server or from an internal web server of another cooking device may be used by the internal web browser of the cooking device.

Accordingly, a system is based on the surprising finding that by means of the integration of a web server into each cooking device of a plurality of cooking devices a monitoring, a control and/or an analysis of each of the said cooking devices may be carried out from any place, from any remote place by means of a conventional web browser that is connected to the internet. This provides for a particularly high degree of flexibility for network access to each cooking device because the place of the access is no longer restricted to the installation site of a remote web server. By means of the additional integration of a web browser into each cooking device it is accomplished that the user interface at each cooking device is unified with the user interface of a remote web browser. Moreover, each internal cooking device web browser may have access to other cooking devices and other remote web servers which provides for a flexible use of network resources with different local positions.

### BRIEF DESCRIPTION OF THE DRAWINGS

Further features and advantages of the invention follow from the description below in which a cooking device according to the invention is explained by way of example with schematic drawings in which:

FIG. 1 shows a diagrammatic representation of network components and network connections of a cooking device of a system having a plurality of cooking devices;

FIG. 2 shows a front view of an arrangement of three cooking devices networked with each other in a system; and

FIG. 3 shows a front view of an alternative arrangement of three cooking devices which are networked with each other in a system.

### DETAILED DESCRIPTION

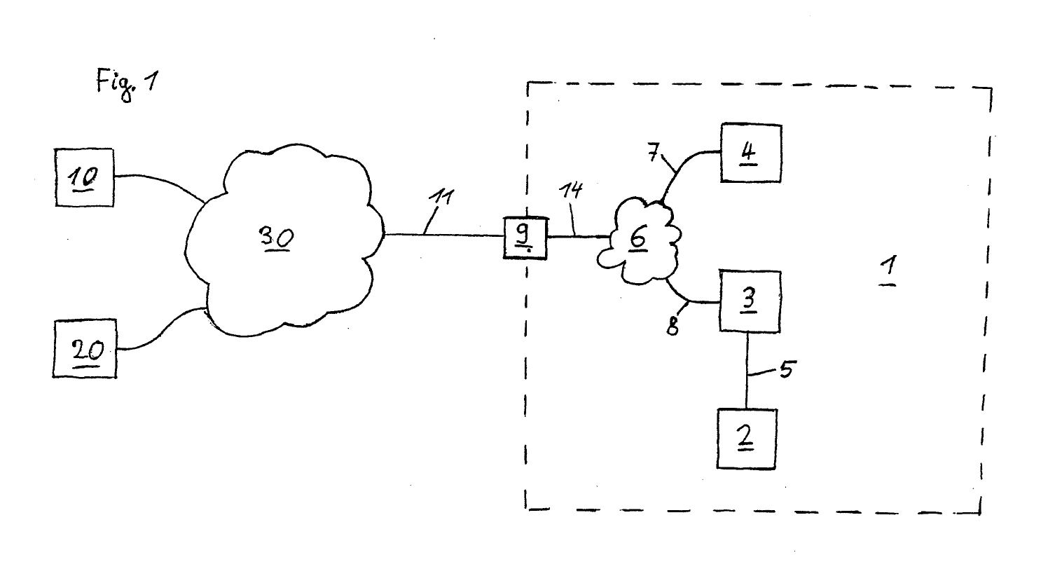

FIG. 1 shows a diagrammatic representation of the configuration of the network components and network connections of a cooking device 1. The dash-lined box defines the area of cooking device 1. A cooking device internal electronic control device 2 is connected via a bi-directional data connection 5 with a cooking device internal web server 3. By means of this data connection 5 web server 3 is enabled to exchange data and instructions for the monitoring, the control and the analysis of a cooking process in a cooking space (not shown) of cooking device 1 with the control device 2. Web server 3 is connected via a network connection 8 to a local network 6 and provides within this network 6 services and/or web services. These services can comprise a control of the devices as well as a readout, a writing and/or a modification of settings and of cooking device configurations, a readout and/or a modification of the running times and running cycles of cooking processes, a readout of service, diagnosis and statistics data, as well as a creation, a management, an uploading and/or a downloading of cooking programs.

A cooking device internal web browser 4 is also connected with the network via a network connection 7 and may have access to the web server 3 and/or use the services of the same. Web browser 4 is connected with a display and control unit (not shown) of cooking device 1.

The terms “internal web server” and “internal web browser” each have a program which runs on one or several cooking device internal data processors. This server-client combination may for instance run on one data processor or on two separate data processors. A combination is also possible where the control unit 2, the internal web server 3 and the internal web browser 4 are integrated on a cooking device internal data processor.

The communication between web server 3 and web browser 4 within the network typically takes place via HTTP (hypertext transfer protocol). The use of another log is also possible, and in this more general case the terms web server and web browser would have to be substituted by the terms server and client.

Hence, the network comprises the cooking device internal local network 6 which is connected via network connections 7, 8 and 14 with web server 3, web browser 4 and an interface 9, in particular a router or a web interface. Interface 9 is connectable to the internet 30 via a network connection 11. This makes it possible that the services of the internal web server 4 may be used by any one or several remote web browsers 20 which are connected to the internet 30. Thus, accessing cooking device 1 is possible from any internet access mechanism via a standard web browser 20.

In order to prevent an unauthorized access to cooking device 1, the internal web server 3 may demand an authentication of a remote user or web browser 20. With a view to further increasing the connection safety, an encoded connection, for instance by means of an SSL (secure sockets layer) log or comparable logs, may be established between the internal web server 3 and the remote web browser 20.

Consequently, convenient access to cooking device 1 is possible at a remote place with a freely available standard web browser 20, irrespective of the operating system or the hardware platform that are used. Moreover, there is no need for using cost-intensive proprietary software for the external control of cooking device 1 when non-standardized, customer-specific or device-specific communication solutions are used.

Another characteristic of cooking device 1 may be that the user interface of the remote web browser 20 is the same as that of the internal web browser 4. Hence, the operator console at cooking device 1 has the same “look and feel” as the operator console at the remote web browser 20. It is also proposed that changes in the state of cooking device 1 are displayed in a synchronized manner at all other web browsers which are connected with web server 3 by means of an access via an internal or remote web browser. Thus, there is no danger of a separate running of the web browsers, and there is no need for a follow-up since the display on the external web browser 20 and on the internal web browser 3 is synchronized.

Vice versa the internal web browser 4 may access further remote web servers 10 and use their services. The user of cooking device 1 may for instance download in an easy manner cooking programs from a remote web server 10 or from another cooking device.

The local network 6 of cooking device 1 may be connected both with the internet 30 and with further local networks or other cooking devices, with or without the interposition of the Internet 30. Thus, an interconnection of several cooking devices into a system according to the invention provides new possibilities of cooking device control, in particular when several cooking devices are arranged side by side as is for instance common in professional large-scale kitchens.

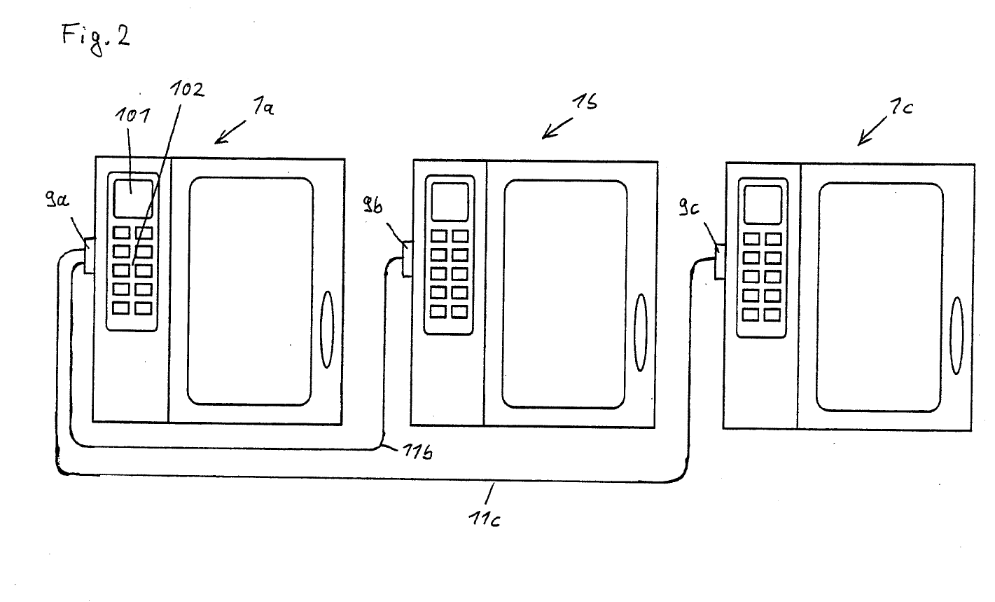

Such an exemplary arrangement of three cooking devices 1a to 1c which are positioned next to each other in a system according to the invention is shown in FIG. 2. The interfaces 9b and 9c of cooking devices 1b and 1c are each connected with interface 9a of cooking device 1a via network connections 11b and 11c. In this manner a network is created which comprises the local networks 6 of the three cooking devices.

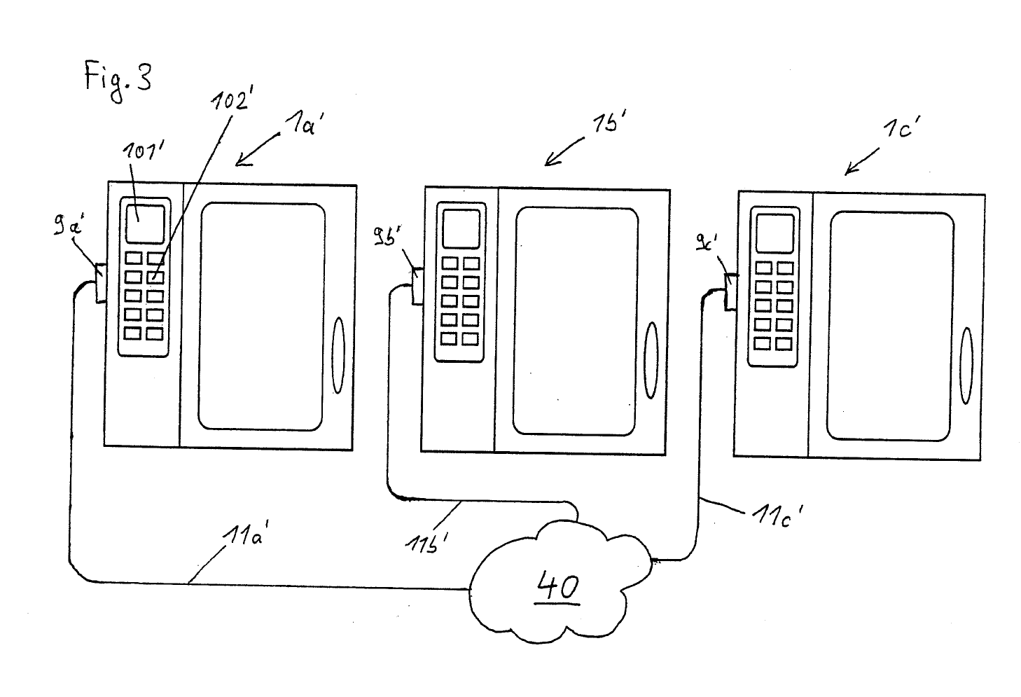

FIG. 3 shows a similar arrangement of three cooking devices 1a′ to 1c′ interconnected in another system according to the invention with an alternative network configuration when compared to FIG. 2. Here, the interfaces 9a′ to 9c′ of the three cooking devices 1a′ to 1c′ are connected via network connections 11a′ to 11c′ with a network 40, in particular the Internet.

In the configurations which are shown in FIG. 2 and in FIG. 3 the web browser of a cooking device 1a, 1a′ may hence use the services of the three internal web servers of the cooking devices 1a to 1c, 1a′ to 1c′. Via the operator console 102, 102′ and the display unit 101, 101′ which are connected with the internal web browser of a cooking device 1a, 1a′, a user may simultaneously monitor all three cooking devices 1a to 1c, 1a′ to 1c′.

When a larger quantity of cooking items is to be cooked in the same manner, for instance when banquet dishes are to be warmed up or finished, the interconnection of several cooking devices to a system according to the invention is particularly helpful. With reference to the case which is shown in FIG. 2 and in FIG. 3, the three cooking devices 1a to 1c, 1a′ to 1c′ may first be separately fed with cooking stuff. Thereupon, the cooking process of all three cooking devices may be monitored in a synchronized manner via the internal web browser of a cooking device 1a, 1a′. Consequently, the programming and/or operation of the individual cooking devices is not necessary which results in the saving of time and costs. Hence, the three cooking devices may be optionally interconnected into a single large virtual cooking device. This provides for a very flexible adjustment of the capacities of the cooking devices to the respective requirements in professional kitchen operation.

The above-mentioned network connections may be implemented in different variants or combinations of the variants. Apart from an electrical cable connection, for instance also optical network connections or wireless connections based on the bluetooth or wireless-LAN technology are possible.

While examples have been used to disclose the invention, including the best mode, and also to enable any person skilled in the art to make and use the invention, the patentable scope of the invention is defined by claims, and may include other examples that occur to those skilled in the art.

It is claimed:

1. A system comprising:
a plurality of cooking devices that are interconnected through interfaces;
each cooking device being connected to at least one internal web server that is connected to a network and that provides in the network services for the monitoring and control of at least one of the plurality of cooking devices; and
at least one internal web browser that is connected to the network and that can use at least the services of one of the internal web servers so that a cooking process of the plurality of cooking devices is monitored synchronously via the internal web browser of one of the cooking devices.

2. The system according to claim 1, wherein
each internal web server is a server of the services of which are callable via an HTTP.

3. The system according to claim 1, wherein
each internal web browser is a client that accesses the network via HTTP with the services being web services.

4. The system according to claim 1, wherein
the services of each internal web server are callable from at least one remote web browser that is connected to the network.

5. The system according to claim 1, wherein,
each internal web browser uses the services of at least one remote web server that is connected to the network.

6. The system according to claim 1, wherein,
the services of an internal web server comprise:
a control of at least one cooking device,
a readout, a writing or a modification of settings and of cooking device configurations,
a readout or a modification of running times and running cycles of cooking processes,
a readout of service, diagnosis and statistics data, and
a creation, a management, an uploading or a downloading of cooking programs.

7. The system according to claim 6, wherein,
each internal web browser is an active component of the operation of at least one cooking device through the use of the services of each internal web server.

8. The system according to claim 1, wherein,
each internal web server is bi-directionally connected via a data line with an electronic control device of a cooking device.

9. The system according to claim 1, wherein,
the network comprises:
a local network of a cooking device with the local networks being inter-connectable via a respective interface or being connectable with another cooking device.

10. The system according to claim 1, wherein,
the network comprises:
the internet with each local network being connectable via an interface with the internet.

11. The system according to claim 9, wherein
the interface is a web interface.

12. The system according to claim 1, wherein,
services for a cooking device from a central web server or from an internal web server of another cooking device are used from the internal web browser of at least one cooking device.
